(19) United States
(12) Patent Application Publication
(10) Pub. No.: US 2021/0239559 A1
(43) Pub. Date: Aug. 5, 2021

(54) PRESSURE SENSING APPATUS WITH MEMS

(71) Applicant: Knowles Electronics, LLC, Itasca, IL (US)

(72) Inventors: Andy Unruh, San Jose, CA (US); Sung Bok Lee, Chicago, IL (US); Pete Loeppert, Durand, IL (US); Wade Conklin, Chicago, IL (US); Michael Kuntzman, Chicago, IL (US); Vahid Naderyan, Itasca, IL (US)

(73) Assignee: Knowles Electronics, LLC, Itasca, IL (US)

(21) Appl. No.: 16/313,889

(22) PCT Filed: Jul. 24, 2017
(86) PCT No.: PCT/US2017/043530

§ 371 Date: Dec. 28, 2018

Related U.S. Application Data
(60) Provisional application No. 62/366,970, filed on Jul. 26, 2016.

(51) Int. Cl. G01L 19/00; G01L 9/00; H04R 19/00; H04R 19/04

(52) U.S. Cl. CPC G01L 19/0092; G01L 9/0016; G01L 9/0047; H04R 2499/15; H04R 19/04; H04R 2499/11; H04R 19/005

(57) ABSTRACT

In accordance with one aspect, a device is provided having a transducer comprising a conductor, a diaphragm configured to move relative to the conductor, and a reference volume in communication with the external environment. The diaphragm separates the reference volume and the external environment. The device further includes a controller operably coupled to the transducer and configured to determine an air pressure of an external environment based at least in part on movement of the diaphragm.

### CROSS-REFERENCE TO RELATED APPLICATIONS

This application claims the benefit of and priority to U.S. Provisional Patent Application No. 62/366,970, filed Jul. 26, 2017, the entire contents of which are incorporated herein by reference.

### BACKGROUND

Various types of microelectromechanical systems (MEMS) have been used through the years in many different devices, such as cell phones, tablets, personal media devices, laptops, computers, headsets, and other devices.

For example, a device may have a pressure-sensing MEMS to detect barometric pressure in the ambient air. One prior pressure-sensing MEMS has a sealed volume and a movable diaphragm separating the sealed volume from the ambient air. The pressure sensor detects changes in the ambient air pressure by sensing movement of the diaphragm. However, the sealed volume of the MEMS may be difficult to manufacture with an air-tight seal. Further, the selected reference volume must remain sealed over the lifetime of the associated device, such as a cell phone, in order to provide accurate pressure sensing. This further complicates design and assembly of the pressure sensor.

### SUMMARY

An illustrative device includes a transducer and a controller. The transducer includes a first conductor, a diaphragm configured to move relative to the first conductor, and a reference volume in communication with an external environment. The diaphragm separates the reference volume and the external environment. The controller is operably coupled to the transducer and configured to determine an air pressure of the external environment based at least in part on movement of the diaphragm.

An illustrative device includes a transducer and a controller. The transducer includes a reference volume in communication with an external environment. The transducer also includes a first conductor and a second conductor spaced apart from each other and movable relative to each other in response to changes in an air pressure of the external environment. Movement of the first and second conductors relative to each other causes the reference volume to change in volume. The controller is operably coupled to the transducer and is configured to apply a voltage to at least one of the first conductor and the second conductor and determine the air pressure of the external environment based at least in part on an electrical potential between the first conductor and the second conductor caused by the voltage.

An illustrative method of determining air pressure of an external environment includes moving a diaphragm of a transducer and changing a size of a reference volume of the transducer. The reference volume is vented to the external environment. The method also includes determining the air pressure of the external environment based at least in part on movement of the diaphragm of the transducer.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a schematic view of a pressure-sensing apparatus including a transducer in accordance with an illustrative embodiment.

FIG. 2 is a graph of measured noise power density versus frequency produced using the pressure-sensing apparatus of FIG. 1 in accordance with an illustrative embodiment.

FIG. 3 is a graph of external environment resonance frequency of the transducer of FIG. 1 versus gauge pressure determined from the noise power density of FIG. 2 showing a nearly linear relationship between the external environment resonance frequency and gauge pressure in accordance with an illustrative embodiment.

FIG. 4 is a cross-sectional schematic view of a pressure-sensing apparatus in accordance with an illustrative embodiment.

FIG. 5 is a cross-sectional schematic view of a dual transducer system including an acoustic-sensing transducer and a pressure-sensing transducer in accordance with an illustrative embodiment.

FIG. 6 is a flow chart illustrating a method of determining pressure using a transducer in accordance with an illustrative embodiment.

FIG. 7 is a cross-sectional schematic view of a pressure-sensing apparatus including a transducer in accordance with an illustrative embodiment.

FIG. 8 is a cross-sectional schematic view of the pressure-sensing apparatus of FIG. 7 showing a diaphragm of the transducer in a deflected orientation in accordance with an illustrative embodiment.

FIG. 9 is a schematic view of a pressure-sensing apparatus including a transducer in accordance with an illustrative embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

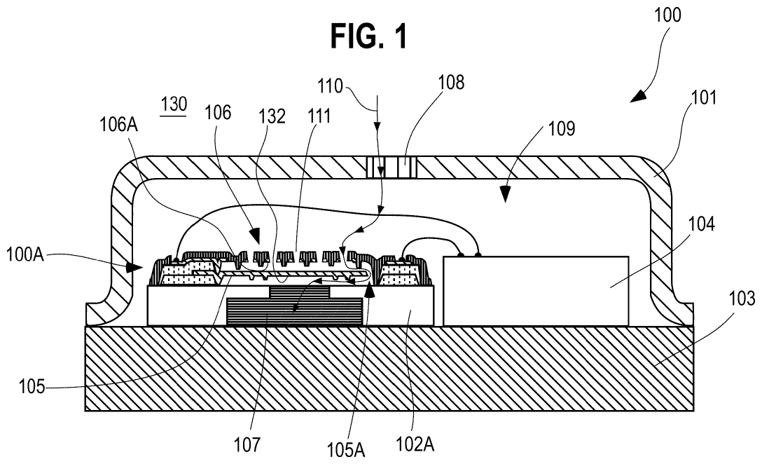

Referring to FIG. 1, a pressure-sensing apparatus 100 is provided that includes a microelectromechanical system (MEMS), such as a pressure-sensing transducer 100A, and a controller, such as an application-specific integrated circuit (ASIC) 104. In addition to sensing pressure, the transducer 100A may be configured to operate as a microphone. The apparatus 100 includes a lid 101, a base 103, a port 108, and a front volume 109. The transducer 100A includes a diaphragm 105, a substrate 102A, a back plate 106, and defines at least a portion of a reference volume 107. The diaphragm 105 may be a conductor and the back plate 106 contains a conductor 106A. The reference volume 107 is small, such as in the range of approximately 1×10⁻⁴ mm³ to approximately 1 mm³, and is enclosed by the transducer 100A and the base 103. In one form, the base 103 is a printed circuit board. The ASIC 104 can supply voltage necessary to operate the transducer 100A as a microphone and amplify the signals generated by the transducer 100A. In alternative embodiments, the ASIC 104 can perform any suitable function. In one form, the apparatus 100 includes a Knowles® SPU0410 top port microphone.

Air may travel along a leakage path 110 connecting an external environment 130, front volume 109, and reference volume 107. The leakage path 110 extends through at least one hole or vent 105A in the diaphragm 105 and at least one hole or vent 111 in the back plate 106. In this manner, the reference volume 107 is in communication with the external environment 130. Further, the vent 105A and the vent 111 permit air to travel between the reference volume 107 and front volume 109.

It has been discovered that the small size of the reference volume 107 causes the reference volume 107 to behave like a spring in response to changes in displacement (or distance) of the diaphragm 105. Because air within the reference volume 107 acts as a spring, the ASIC 104 can determine the air pressure of the external environment 130 based on the ability of the diaphragm 105 to dynamically compress the reference volume 107 despite the reference volume 107 being in communication with the external environment 130.

More specifically, the spring constant or stiffness κ_{RV} of the reference volume 107 against compression and expansion due to movement of the diaphragm 105 is proportional to ambient air pressure. To estimate the stiffness κ_{RV} of the reference volume 107, an equation for relating pressure change to volume change can be used:

ΔP/P₀=γΔV/V (Equation 1),

where γ is the ratio of the specific heat of air at constant pressure to the specific heat at constant volume. The variable γ may be approximately 1.4 for air. Pₒ is the atmospheric pressure, and the equilibrium pressure about which pressure change, ΔP, occurs.

The motion of the diaphragm 105 may be approximated as a piston motion that compresses or expands the reference volume 107. With this approximation and Equation 1 above, the stiffness κ_{RV} of the air within the reference volume 107 may be determined using the following equation:

Δforce/Δdisplacement=A²P₀γ/V=κ_{RV} (Equation 2),

where A is the area of surface 132 (see FIG. 1) of the diaphragm 105, P₀ is the atmospheric pressure, and V is the volume of the reference volume 107. Using equation 2, the stiffness κ_{RV} of the reference volume 107 is proportional to the atmospheric pressure P₀ and to the squared area A of surface 132, and inversely proportional to the volume V of the reference volume 107.

Equation 2 may be used to determine variations in P₀. Equation 2 indicates that sensitivity of κ_{RV} to P₀ may be made large by minimizing the volume V (i.e., making V as small as reasonably possible and/or making the area A of the surface 132 as large as possible). Therefore, measurement of the reference volume stiffness κ_{RV} can be used to gauge the atmospheric pressure P₀, and for highest sensitivity it may be desired to design the reference volume 107 as small as possible and the area of the surface 132 as large as possible. There are a number of ways to measure the stiffness κ_{RV} of the reference volume 107; one way is to measure the external environment 130 resonance of the transducer 100A, which is affected by changes in the stiffness of the reference volume 107.

With respect to FIG. 1, one way to measure the external environment 130 resonance of the transducer 100A is to track the location of the peak in the noise power density spectrum when the transducer 100A is operated as a microphone. The random motion of air hitting the diaphragm 105 causes signals to generate on the conductor 106A of the back plate 106 in much the same way sound pressure vibrating the diaphragm 105 would generate acoustic signals on the conductor 106A, both of which would be amplified by the ASIC 104 in an illustrative embodiment. At the external environment 130 resonance frequency, the diaphragm 105 moves more than at non-resonance frequencies. That is, noise power is larger at external environment 130 resonance. When the stiffness κ_{RV} of the reference volume 107 increases due to increased atmospheric pressure P₀, the frequency of an external environment 130 resonance of the transducer 100A increases. When the stiffness κ_{RV} of the reference volume 107 decreases due to decreased atmospheric pressure P₀, the frequency of the external environment resonance of the transducer 100A decreases.

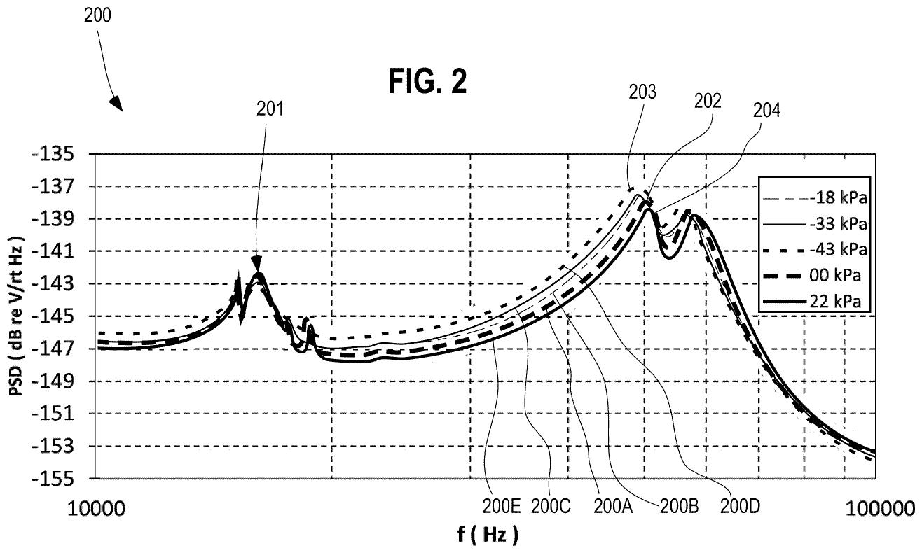

With respect to FIG. 2, a graph 200 shows noise power spectra that corresponds to signals received at the ASIC 104 and caused by air molecules randomly striking the diaphragm 105 at different ambient pressures. The y-axis is air pressure of the external environment 130, and the x-axis is the signal frequency. In the graph 200, the air pressure of the external environment 130 is indicated in gauge pressure such that 0.0 kPa is equivalent to one unit of atmospheric pressure (1.0 Atm), negative values indicate pressures below 1.0 Atm, and positive values indicate pressures above 1.0 Atm. The curve 200A of graph 200 is the power spectrum density (PSD) as a function of frequency for the transducer 100A at 0.0 kPa of gauge pressure. Similarly, the curve 200B is the PSD at −18 kPa, the curve 200C is the PSD at −33 kPa, the curve 200D is the PSD at −43 kPa, and the curve 200E is the PSD at 22 kPa gauge pressure.

In one form, the pressure sensing apparatus 100 can operate as an altimeter and be used to determine altitude based on air pressure of the external environment 130, which generally decreases as altitude increases. For example, the device including the pressure sensing apparatus 100 may determine the elevation of the device, such as the height above mean sea level, based on the air pressure of the external environment 130. In one approach, determining the elevation of the device includes determining a noise spectrum similar to graphs 200A, 200B, etc. for the current external environment 130 and comparing the noise spectrum to a baseline such as a noise spectrum for the device at sea level.

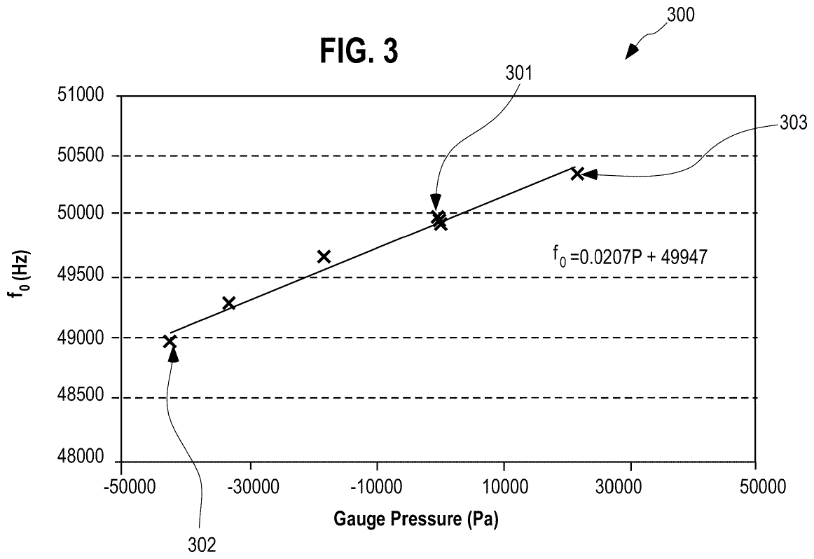

With continued reference to FIG. 2, the transducer 100A has a first, port resonance 201 at approximately 16 kHz and a second, external environment 130 resonance (see 202, 203, 204) at approximately 50 kHz. When the device containing the pressure-sensing apparatus 100 is at a higher altitude, the air pressure of the external environment 130 decreases and the external environment resonance 202 will be at a lower frequency. For example, the transducer 100A at a gauge pressure of −43 kPa in curve 200D is at a lower gauge pressure than the transducer 100A at a gauge pressure of 0.0 kPa (graph 200A) and the reference volume 107 is softer (i.e. lower κ_{RV}) at −43 kPa, than at 0.0 kPa. This results in a lower external environment 130 resonance 203 (approximately 49 kHz; see FIG. 3 and discussion below) of the −43 kPa pressure curve 200D than the external environment 130 resonance 202 of the 0.0 kPa pressure curve 202A. The transducer 100A at 22 kPa of gauge pressure shown by the curve 200E is operating under higher gauge pressure than the transducer 100A at 0.0 kPa in curve 200A and the reference volume 107 is stiffer (i.e. higher κ_{RV}) at 22 kPa as compared to the transducer 100A at 0.0 kPa. This results in the transducer 100A having a higher external environment 130 resonance 204 at 22 kPa in curve 200E (approximately 50.5 kHz) than the external environment 130 resonance 202 of the 0.0 kPa in curve 200A.

FIG. 3 shows the frequency, f₀, of the external environment 130 resonance of the transducer 100A at the different gauge pressures of curves 200A, 200B, 200C, 200D, 200E. The y-axis is the frequency f₀, and the x-axis is the gauge pressure of the external environment 130. The 0.0k Pa curve 200A of FIG. 2 has a frequency f₀ of approximately 50 kHz shown by reference numeral 301. When the air pressure of the external environment 130 is lower, the external environment 130 resonance of the transducer 100A will be at a lower frequency than when the air pressure of the external environment 130 is higher. For example, when the air pressure of the external environment 130 is −43 kPa, the external environment 130 resonance 203 of the transducer 100A shifts to approximately 49 kHz shown by reference numeral 302. In another example, when the air pressure of the external environment 130 is 22 kPa, the external environment 130 resonance 204 of the transducer 100A shifts to approximately 50.5 kHz, as shown by reference numeral 303.

An empirical linear relation exists between air pressure of the external environment 130 and the frequency of the external environment 130 resonance of the transducer 100A. Using a linear regression, an equation modeling the approximation is determined to be:

f₀=0.00207P+49947 (Equation 3),

where P is the atmospheric pressure in Pa (e.g., the pressure of the external environment 130), and f₀ is the frequency of the external environment 130 resonance of the transducer 100A in Hz. Once Equation 3 has been calculated for a given transducer 100A, Equation 3 may be used to determine the air pressure P of the external environment 130.

Because noise is measured in the same manner as sound, the same apparatus 100 can be used to measure pressure P₀ as well as sound. That is, the apparatus 100 can operate both as a pressure sensor and as a microphone. In an illustrative embodiment, the apparatus 100 operates as a pressure sensor and a microphone simultaneously. For example, the apparatus 100 can output a signal corresponding to a sensed audio signal, and the frequency response of the output signal can be monitored to determine the pressure of the external environment 130.

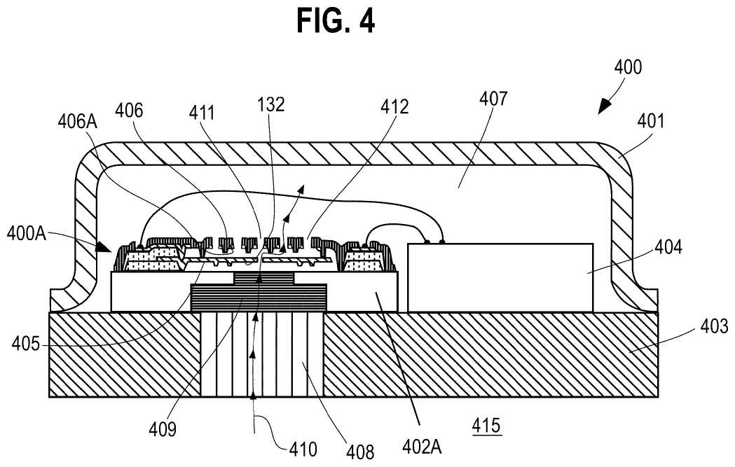

Referring now to FIG. 4, a pressure-sensing apparatus 400 is shown in accordance with an illustrative embodiment. The pressure-sensing apparatus 400 includes a transducer 400A, a lid 401, an ASIC 404, and a base 403 to which the transducer 400A is mounted. The base 403 has a port 408 that extends through the base 403 and communicates with the external environment 415. The transducer 400A includes a diaphragm 405, a substrate 402A, and a back plate 406. The apparatus 400 includes a reference volume 407 and a front volume 409. The pressure-sensing apparatus 400 is similar in many respects in structure and operation to the pressure-sensing apparatus 100, except that the reference volume 407 of the pressure-sensing apparatus 400 is larger than the front volume 409, whereas the reference volume 107 of the pressure-sensing apparatus 100 is smaller than the front volume 109 of FIG. 1. Air may travel along a leakage path 410 that connects the external environment 415, the port 408, the reference volume 407, and the front volume 409. The diaphragm 405 has at least one vent 411 and the back plate 406 has at least one vent 412 that permit air to travel between the reference volume 407 and the front volume 409. In an illustrative embodiment, the transducer 400A includes two or more vents 411 and two or more vents 412.

In a manner similar to the ASIC 104, the ASIC 404 has the ability to supply direct current (DC) bias to the transducer 400A and amplify the signal generated by the transducer 400A. That is, the ASIC 104 can operate the apparatus 400 as a microphone. The random impacts of air molecules against the diaphragm 405 will vibrate the diaphragm 405 toward and away from the back plate 406. As a result, a conductor 406A of the back plate 406 generates signals that correspond to the changing electrical potential between the diaphragm 405 and the conductor 406A. In an illustrative embodiment, this signal is amplified by the ASIC 404. Analyzing the external environment 415 resonance frequency of the reference volume 407, the air pressure of the external environment 415 may be determined as discussed above with respect to FIGS. 2 and 3.

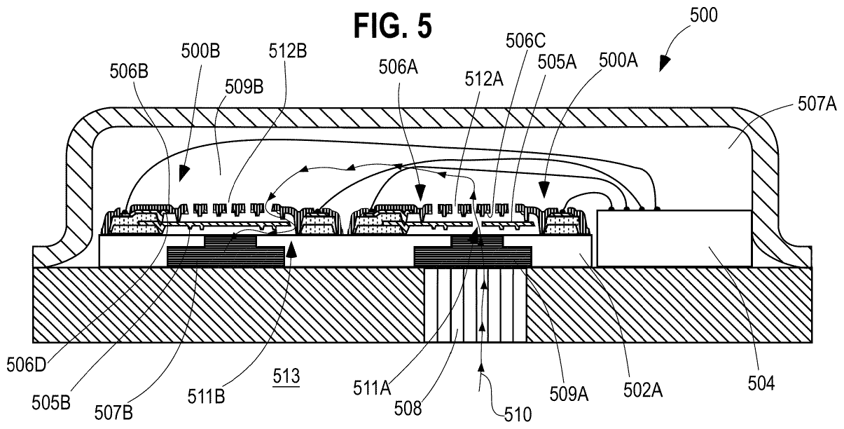

FIG. 5 is a cross-sectional schematic view of a dual transducer system including an acoustic-sensing transducer and a pressure-sensing transducer in accordance with an illustrative embodiment. In the dual transducer apparatus 500, an acoustic-sensing transducer 500A and a pressure-sensing transducer 500B operate independently, yet are integrated in the dual transducer apparatus 500. In this respect, the pressure-sensing transducer 500B and the acoustic-sensing transducer 500A provide different functionality in a compact package. Equation 1 and Equation 2 show that to achieve high sensitivity to pressure, the reference volume may be small as possible. It is generally accepted that to achieve high sensitivity to sound, it is desirable to have a reference volume as large as possible. The dual transducer apparatus 500 allows the two sensing functions to have two separate reference volumes.

The dual transducer apparatus 500 has a leakage path 510 that extends through a port 508, a front volume 509A, a substrate 502A, at least one vent 511A of a diaphragm 505A, and at least one vent 512A of a back plate 506A with a back plate conducting layer 506C, and into a back volume 507A of the acoustic-sensing transducer 500A. The leakage path 510 further extends into a front volume 509B, through at least one vent 512B of a back plate 506B with a back plate conducting layer 506D, through at least one vent 511B of a diaphragm 505B, and into a reference volume 507B of the pressure-sensing transducer 500B. Air may move along the leakage path 510 such that the reference volume 507B is in communication with an external environment 513.

In an illustrative embodiment, the ASIC 504 has the ability to apply bias to the transducers 500A and 500B and amplify the signals generated by the transducer 500A due to sound impinging on the diaphragm 505A and amplify the signals generated by the transducer 500B due to random air movements impinging on the diaphragm 505B. The diaphragms 505A, 505B and conducting layers 506C, 506D on the back plates 506A, 506B may be fabricated from doped polysilicon or metals compatible with MEMS fabrication.

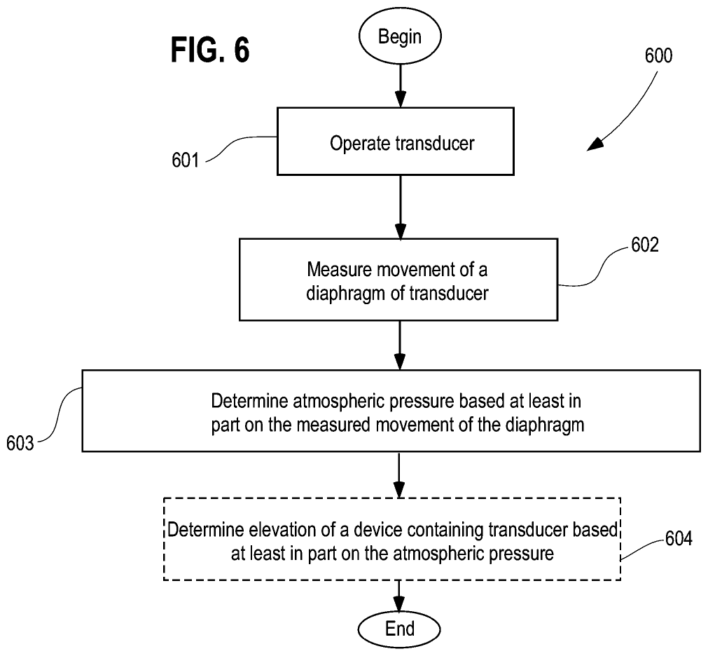

FIG. 6 is a flow chart illustrating a method of determining pressure using a transducer in accordance with an illustrative embodiment. In an illustrative embodiment, the method of FIG. 6 can be performed by using the pressure-sensing apparatus 100 or any other suitable device. In alternative embodiments, additional, fewer, and/or different operations may be performed. Also, the use of a flow chart and arrows is not meant to be limiting with respect to the order or flow of operations. For example, in alternative embodiments, two or more of the operations may be performed simultaneously.

The operation 601 includes operating a transducer. For example, the operation 601 can include applying voltage to the conductor 106A of the back plate 106 of the transducer 100A. In such an example, an opposite charge accumulates on the diaphragm 105, which creates an electric potential or voltage difference between the conductor 106A of the back plate 106 and the diaphragm 105.

The operation 602 includes measuring movement of a diaphragm of a transducer, such as the diaphragm 105. In an illustrative embodiment, random impacts of air molecules against the diaphragm 105 causes the diaphragm 105 to vibrate, thus changing the electric potential between the diaphragm 105 and the conductor 106A of the back plate 106. The ASIC 104 can detect the changes in the electric potential and can send signals to devices connected to the apparatus 100, such as amplifiers and processors.

Using the example of FIG. 1, the transducer 100A has an external environment 130 resonance with a frequency that varies depending on the air pressure of the external environment 130. The operation 603 includes determining the atmospheric pressure (e.g., of the external environment 130) based at least in part on the measured movement of a diaphragm (e.g., the diaphragm 105). In one embodiment, the operation 600 includes using the frequency of the detected external environment resonance, such as external environment resonance 202, and an empirical relationship between resonance frequency and air pressure, such as Equation 3 above, to determine the air pressure of the external environment 130.

The operation 604 includes determining the elevation of a device containing the transducer (e.g., the pressure-sensing apparatus 100) based at least in part on the air pressure of the external environment 130 determined at operation 603. In some embodiments, the operation 604 may not be performed. In such embodiments, the determined atmospheric pressure can be used for any suitable purpose. In one embodiment, the elevation of the device is determined by solving an equation that correlates ambient air pressure and elevation. For example, the following equation may be used:

H=8443.75−0.083P (Equation 4),

where H is the height in meters above average sea level and P is the atmospheric pressure in kPa.

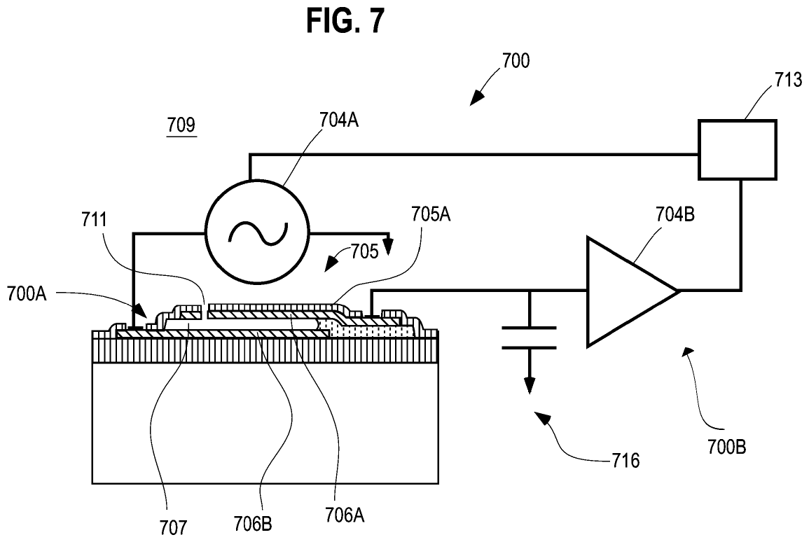

FIG. 7 is a cross-sectional schematic view of a pressure-sensing apparatus including a transducer in accordance with an illustrative embodiment. The pressure-sensing apparatus 700 includes a transducer 700A and a controller 700B. In an illustrative embodiment, the controller 700B includes an ASIC. The transducer 700A has a diaphragm 705 with a dielectric layer 705A and a conductor 706A, a conductor 706B, and a reference volume 707 in communication with an external environment 709 via a vent 711 in the diaphragm 705. The controller 700B includes a processor 713, a variable voltage source 704A configured to send an alternating current (AC) signal to the conductors 706A, 706B, and a detector 704B. While a DC signal continuously directs an electric charge in a unidirectional manner, the flow of electric charge of an AC signal periodically reverses direction. The AC signal creates an oscillating voltage, and the amplifier 704B is configured to detect the movement of the diaphragm 705 in the form of an electric signal in response to the oscillating voltage. A ground 716 is used as a reference point from which the voltage is measured by the amplifier 704B. The processor 713 determines air pressure of the external environment 709 based at least in part on movement of the diaphragm 705.

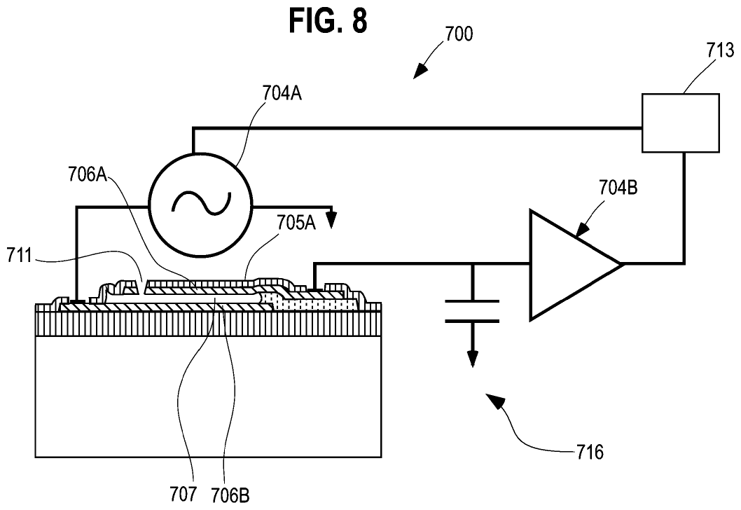

With respect to FIG. 7, the processor 713 operates the variable voltage source 704A to send an AC signal which causes a charge to build up on the conductor 706B and an induces an opposite charge in the conductor 706A of the diaphragm 705. The AC signal applied to the conductors 706A, 706B electrostatically actuates the diaphragm 705. With reference to FIG. 8, the diaphragm 705 is shown deflected due to the different charges of the conductors 706A, 706B. The changing distance between the conductors 706A, 706B changes the electric potential between the conductors 706A, 706B. The amplifier 704B senses the changing electric potential and communicates corresponding signals to the processor 713.

The pressure sensing-apparatus 700 may use a number of different approaches to determine air pressure of the external environment 709. In one approach, the processor 713 operates the voltage source 704A to apply an AC signal with a varying frequency to sweep a frequency band where the external environment 709 resonance of the transducer 700A will likely occur. At the external environment 709 resonance of the transducer 700A (e.g., at the external environment 709 resonance of the system consisting of the diaphragm 705 and reference volume 707) the amplitude of movement of the diaphragm 705 is large and the processor 713 locates the external environment 709 resonance frequency by identifying the frequency at which maximum amplitude of movement of the diaphragm 705 occurs and the resulting change in electrical potential between the conductors 706A, 706B. Approaches described in relation to FIGS. 1, 4, and 5 monitored the actuated diaphragm 105, 405, 505A, 505B by the random impingement of air. In the embodiment shown in FIG. 7, voltage is used to actuate the diaphragm 705.

In another approach, the processor 713 determines the frequency of the external environment 709 resonance of the transducer 700A by measuring the frequency of the AC signal applied to the conductors 706A, 706B. In such an approach, at the external environment 709 resonance of the transducer 700A, the phase of movement of the diaphragm 705 differs from the AC signal by 180 degrees. The processor 713 thereby can determine the frequency of the external environment 709 resonance of the transducer 700A by identifying the frequency at which the phase change of the AC signal occurs.

The frequency of the external environment 709 resonance of the transducer 700A may be empirically related to the air pressure of the external environment 709 in a manner similar to the empirical relationship discussed above with respect to FIG. 3. The processor 713 may determine the air pressure of the external environment 709 by solving the empirical equation of the relationship for pressure using the determined frequency of the external environment 708 resonance of the transducer 700A.

The AC voltage source 704A of the pressure-sensing apparatus 700 causes movement of the diaphragm 705 in the embodiment shown in FIGS. 7 and 8, whereas the random impacts of air molecules against the diaphragm 105 cause movement of the diaphragm 105 in the embodiments shown in FIGS. 1, 4, and 5. However, the back volumes 107, 707 are in communication with the external environments 130, 709 and have a stiffness that is directly proportional to air pressure in the external environment 130, 709 as discussed above. Thus, the approaches discussed above for determining air pressure of the external environment 130, including the method 600, may be used with the pressure sensing apparatus 700.

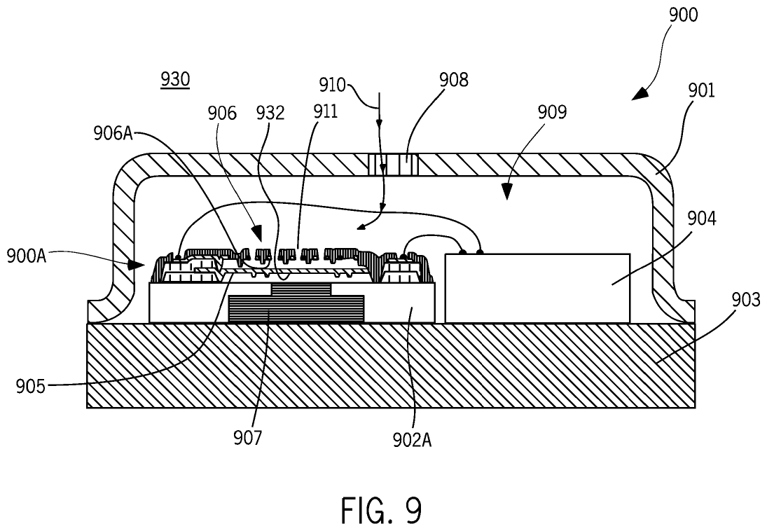

Referring to FIG. 9, a pressure-sensing apparatus 900 is shown similar to the pressure-sensing apparatus 100. The pressure-sensing apparatus 900 includes a microelectromechanical system (MEMS), such as a pressure-sensing transducer 900A, and a controller, such as an application-specific integrated circuit (ASIC) 904. In addition to sensing pressure, the transducer 900A may be configured to operate as a microphone. The apparatus 900 includes a lid 901, a base 903, a port 908, and a front volume 909. The transducer 900A includes a diaphragm 905, a substrate 902A, a back plate 906, and defines at least a portion of a reference volume 907. The diaphragm 905 may be a conductor and the back plate 906 contains a conductor 906A. The reference volume 907 is small, such as in the range of approximately 1×10⁻⁴ mm³ to approximately 1 mm³, and is enclosed by the transducer 900A and the base 903. In one form, the base 903 is a printed circuit board. The ASIC 904 can supply voltage necessary to operate the transducer 900A as a microphone and amplify the signals generated by the transducer 900A. In alternative embodiments, the ASIC 904 can perform any suitable function. In one form, the apparatus 900 includes a Knowles® SPU0410 top port microphone.

Air may travel along a leakage path 910 connecting an external environment 930 to the front volume 909. Different from the pressure-sensing apparatus 100, the leakage path 910 does not extend to the reference volume 907. There are no holes or vents in the diaphragm 905. There are holes and/or vents 911 in the backplate 906 such that one surface of the diaphragm is exposed to the external environment 930.

The small size of the reference volume 907 causes the reference volume 907 to behave like a spring in response to changes in displacement (or distance) of the diaphragm 905. Because air within the reference volume 907 acts as a spring, the ASIC 904 can determine the air pressure of the external environment 930 based on the ability of the diaphragm 905 to dynamically compress the reference volume 907. The air pressure of the external environment can be calculated based upon the surface area of the diaphragm 932 as described above.

The reference volume 907 has an internal air pressure that is not equalized with the air pressure of the external environment 930. Accordingly, the diaphragm 905 can be deformed based upon differences in pressure between the reference volume 107 and the air pressure of the external environment 930. Any deformations of the diaphragm, not caused by acoustic waves, can cause performance issues when the apparatus 900 acts as a pressure-sensing apparatus and a microphone. To correct air pressure deformations, a DC bias can be applied to the diaphragm to return the diaphragm 905 to a non-deformed/non-deflected state with regard to the air pressure from the external environment 930. The amount of DC bias used to return the diaphragm to the non-deformed state can be used to calculate the external air pressure 930.

In one embodiment, the pressure-sensing apparatus 930 operates concurrently as a microphone. Acoustic waves will deform the diaphragm 905 and these deformations from acoustic waves cannot be removed without affecting the performance of the microphone. In various embodiments, to remove diaphragm deformation caused by the air pressure differences between the reference volume and the external environment without removing deformations caused by acoustic waves, a low pass filter can be used. The output from the microphone can be passed through a low-pass filter. For example, a 1/10 Hz low-pass filter can be used. In other embodiments, any low-pass filter can be used that is below the sound domain or the acoustic domain that the microphone is configured to detect. As air pressure of the external environment 930 is not expected to change rapidly, e.g., compared to changes in air pressure caused by an acoustic wave, the low-pass filter will filter out the deflection caused by acoustic waves and provide an output indicative of the deflection of the diaphragm caused by the difference in the air pressure of the reference volume 907 and the air pressure of the external environment 930. In one implementation, a servo circuit can be used to control the DC bias of the diaphragm. The filtered output can be feed into the servo circuit to control the DC bias that fluctuates as needed to keep the filtered output of the microphone to be zero.

Not having any holes/vents in the diaphragm 905 can have various advantages. Creating vents/holes of a specific size in a diaphragm can be difficult to consistently manufacture. Some variance in the physical properties of holes/vents is likely to occur between microphones. Accordingly, microphones may not have consistent properties compared with one another. These inconsistencies can cause issues with the performance of the microphone.

For example, vents/holes can cause distortion. Distortion can be corrected using algorithms. These algorithms, however, can assume that all microphones operate in a consistent manner. The variances with the properties of the holes/vents can cause algorithms, such as correcting for distortion/noise suppression, to have errors which leads to performance degradation. The size, shape, and/or location of the vents/holes can also impact noise suppression and/or the roll-off frequency. Removing the holes/vents in the diaphragm can eliminate some or all of these issues. For example, microphones can operate more uniformly since different microphones will not have slightly bigger/smaller, differently shaped and/or located holes/vents.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A device comprising:
a transducer comprising:
a first conductor;
a diaphragm configured to move relative to the first conductor;
a reference volume in communication with an external environment, the diaphragm separating the reference volume and the external environment; and
a controller operably coupled to the transducer and configured to determine an air pressure of the external environment based at least in part on movement of the diaphragm.

2. The device of claim 1, wherein the controller is further configured to determine elevation based at least in part on the air pressure of the external environment.

3. The device of claim 1, wherein the controller is configured to determine the air pressure of the external environment based at least in part on a resonance frequency of the transducer.

4. The device of claim 3, wherein the controller is configured to determine the air pressure of the external environment based at least in part on the resonance frequency of the transducer and a relationship between the resonance frequency of the transducer and the air pressure.

5. The device of claim 1, wherein the controller is configured to supply an alternating voltage to the diaphragm and the first conductor to electrostatically actuate the diaphragm and cause movement of the diaphragm relative to the first conductor.

6. The device of claim 5, wherein the controller is configured to apply alternating current to the diaphragm at varying frequencies and the controller is further configured to determine the air pressure of the external environment based at least in part on determining a frequency of the alternating voltage at which a phase change of the voltage occurs.

7. The device of claim 1, wherein the controller is configured to supply voltage to the diaphragm and cause the diaphragm to vibrate which changes the size of the reference volume.

8. The device of claim 7, wherein the diaphragm includes a second conductor and a substrate, wherein to determine the air pressure of the external environment, the controller is configured to determine an electric potential between the first conductor and the second conductor which changes over time with vibration of the diaphragm.

9. The device of claim 8, wherein the reference volume separates the first conductor and the second conductor.

10. The device of claim 1, further comprising a die supporting the first conductor and the diaphragm, wherein the die defines at least a portion of the reference volume.

11. The device of claim 1, further comprising a lid and a base, wherein the lid and the base form a cavity, and wherein the transducer is within the cavity.

12. The device of claim 11, where the transducer is configured to be a microphone.

13. A device comprising:
a transducer comprising:
a reference volume;
a first conductor and a second conductor spaced apart from each other and movable relative to each other in response to changes in an air pressure of an external environment, wherein movement of the first and second conductors relative to each other causes the reference volume to change in volume; and
a controller operably coupled to the transducer and configured to apply a voltage to at least one of the first conductor and the second conductor and determine the air pressure of the external environment based at least in part on an electrical potential between the first conductor and the second conductor caused by the voltage.

14. The device of claim 12, wherein the second conductor is movable in response to air impacting the second conductor, the controller being configured to apply constant voltage to one of the first conductor and the second conductor, the controller being further configured to determine the air pressure of the external environment based at least in part on the electrical potential between the first and second conductors changing in response to movement of the second conductor.

15. The device of claim 12, wherein the controller is configured to apply alternating voltage to the first and second conductors to cause movement of the first conductor, the controller being configured to determine the air pressure of the external environment based at least in part on the electrical potential between the first and second conductors changing in response to movement of the first conductor caused by the alternating voltage.

16. The device of claim 14, wherein the controller is configured to determine the air pressure of the external environment based at least in part by determining a resonance frequency of the transducer.

17. The device of claim 14, wherein the controller is configured to determine the air pressure of the external environment based at least in part by determining a frequency at which phase change of the alternating voltage occurs.

18. The device of claim 12, wherein the transducer comprises a diaphragm that includes the first conductor and a back plate that includes the second conductor.

19. A method of determining air pressure of an external environment comprising:
moving a diaphragm of a transducer and changing a size of a reference volume of the transducer, the reference volume being vented to the external environment; and
determining the air pressure of the external environment based at least in part on movement of the diaphragm of the transducer.

20. The method of claim 19 wherein determining the air pressure of the external environment includes determining the air pressure based at least in part on a resonance frequency of the transducer.
